(19) United States
(12) Patent Application Publication
(10) Pub. No.: US 2025/0022628 A1
(43) Pub. Date: Jan. 16, 2025

(54) COPPER ALLOY WIRE, COVERED WIRE, COVERED WIRE WITH TERMINAL, AND METHOD FOR MANUFACTURING COPPER ALLOY WIRE

(71) Applicants: Sumitomo Electric Industries, Ltd., Osaka-shi, Osaka (JP); AutoNetworks Technologies, Ltd., Yokkaichi, Mie (JP); Sumitomo Wiring Systems, Ltd., Yokkaichi, Mie (JP)

(72) Inventors: Kazuki EHARA, Osaka-shi (JP); Yasuyuki OTSUKA, Yokkaichi (JP); Fumitoshi IMASATO, Yokkaichi (JP); Yusuke OSHIMA, Osaka-shi (JP); Hiroki TSUNEDA, Osaka-shi (JP); Noriaki KUBO, Osaka-shi (JP); Hiroshi FUJITA, Osaka-shi (JP); Sae SHIMIZU, Osaka-shi (JP); Tetsuya KUWABARA, Osaka-shi (JP); Kei SAKAMOTO, Osaka-shi (JP)

(73) Assignees: Sumitomo Electric Industries, Ltd., Osaka-shi, Osaka (JP); AutoNetworks Technologies, Ltd., Yokkaichi, Mie (JP); Sumitomo Wiring Systems, Ltd., Yokkaichi, Mie (JP)

(21) Appl. No.: 18/684,460

(22) PCT Filed: Jun. 7, 2022
(86) PCT No.: PCT/JP2022/022895

§ 371 Date: Feb. 16, 2024

(30) Foreign Application Priority Data
Aug. 31, 2021 (JP) 2021-141928

(51) Int. Cl. H01B 1/02; C22C 9/00; H01B 7/00; H01B 13/00

(52) U.S. Cl. CPC H01B 1/026; C22C 9/00; H01B 7/0009; H01B 13/0016

(57) ABSTRACT

Disclosed herein is a copper alloy wire being a wire rod formed of a copper alloy and having a tensile strength of 400 MPa or more, an elongation at break of 5% or more, a conductivity of 60% IACS or more, and a wire diameter of 0.5 mm or less, wherein the copper alloy has a composition containing 0.05% by mass or more and 1.6% by mass or less of iron, 0.01% by mass or more and 0.7% by mass or less of phosphorus, and 0.05% by mass or more and 0.7% by mass or less of tin with the balance being copper and unavoidable impurities, the copper alloy has a structure containing crystals, and a crystal grain size difference determined as a difference between a maximum crystal grain size and a minimum crystal grain size in a cross-section is 1.0 μm or less.

### TECHNICAL FIELD

The present disclosure relates to a copper alloy wire, a covered wire, a covered wire with terminal, and a method for manufacturing a copper alloy wire.

The present application claims the priority based on Japanese Patent Application No. 2021-141928 filed on Aug. 31, 2021, and incorporates all the contents described in the above Japanese application.

### BACKGROUND ART

Patent Literatures 1 and 2 disclose a thin wire rod that is formed of a copper alloy containing iron, phosphorus, and tin in amounts within specific ranges and has a wire diameter of 0.5 mm or less. The thin wire rod is used for a conductor of a covered wire. The conductor is, for example, a stranded wire obtained by stranding the thin wire rods.
PTL 1: Japanese Patent Laying-Open No. 2018-077941
PTL 2: WO 2018/083836

### SUMMARY OF INVENTION

The present disclosure is directed to a copper alloy wire that is a wire rod formed of a copper alloy and having
a tensile strength of 400 MPa or more,
an elongation at break of 5% or more,
a conductivity of 60% IACS or more, and
a wire diameter of 0.5 mm or less, wherein
the copper alloy has a composition containing 0.05% by mass or more and 1.6% by mass or less of iron, 0.01% by mass or more and 0.7% by mass or less of phosphorus, and 0.05% by mass or more and 0.7% by mass or less of tin with the balance being copper and unavoidable impurities,
the copper alloy has a structure containing crystals, and
a crystal grain size difference determined as a difference between a maximum crystal grain size and a minimum crystal grain size in a cross-section is 1.0 μm or less.

The present disclosure is directed to a method for manufacturing a copper alloy wire, including:
a first step of manufacturing a casting material formed of a copper alloy by continuous casting;
a second step of subjecting the casting material to conform extrusion to manufacture a linear extruded material;
a third step of subjecting the extruded material to wire drawing to manufacture a drawn wire material; and
a fourth step of subjecting the drawn wire material to heat treatment to manufacture a heat-treated material, wherein
the copper alloy has a composition containing 0.05% by mass or more and 1.6% by mass or less of iron, 0.01% by mass or more and 0.7% by mass or less of phosphorus, and 0.05% by mass or more and 0.7% by mass or less of tin with the balance being copper and unavoidable impurities,
a reduction of area by the conform extrusion is 50% or more,
a temperature of the extruded material just after conform extrusion is 350° C. or more, and
a temperature of the heat treatment is 350° C. or more.

### BRIEF DESCRIPTION OF DRAWINGS

FIG. 1 is a schematic perspective view of an example of a copper alloy wire according to an embodiment.

FIG. 2 is a sectional view taken along a line II-II shown in FIG. 1.

FIG. 3 is a diagram for illustrating a method for measuring an average crystal grain size.

FIG. 4 is a schematic perspective view of an example of a covered wire according to an embodiment which includes, as a conductor, a copper alloy stranded wire according to an embodiment.

FIG. 5 is a schematic configuration diagram of an example of a covered wire with terminal according to an embodiment.

FIG. 6 is a diagram for illustrating an example of a conform extruder used in a method for manufacturing a copper alloy wire according to an embodiment.

FIG. 7 is a schematic enlarged view of part of cross-section of a copper alloy wire of Sample No. 1-1 in Test Example 1.

FIG. 8 is a schematic enlarged view of part of cross-section of a copper alloy wire of Sample No. 1-102 in Test Example 1.

### DETAILED DESCRIPTION

[Problem to be Solved by the Present Disclosure]

There is a demand for a copper alloy wire having a good balance of strength and elongation.

The copper alloy wire disclosed in Patent Literatures 1 and 2 is formed of the above-described copper alloy having a specific composition and is therefore excellent in strength. The copper alloy wire is desired to be further improved in strength but may be reduced in elongation along with the improvement in strength.

Further, such a copper alloy wire is desired to be excellent also in manufacturability.

As described in Patent Literatures 1 and 2, a manufacturing process of the above-described thin wire rod typically includes the step of subjecting a thick material to wire drawing and the step of subjecting a drawn wire material to heat treatment. The thick material is, for example, a casting material. A casting material formed of the above-described copper alloy having a specific composition may have a structure in which a compound containing iron and phosphorus is unevenly distributed. When the thick material in which the compound is unevenly distributed is subjected to wire drawing, wire breakage resulting from the compound is likely to occur during wire drawing. The occurrence of wire breakage reduces the productivity of a drawn wire material, which finally reduces the productivity of a thin wire rod. Further, in the step of heat treatment, temperature control needs to precisely be performed to maintain high strength while improving elongation. This also may reduce the productivity of a thin wire rod.

One of the purposes of the present disclosure is to provide a copper alloy wire having a good balance of strength and elongation. The other purpose of the present disclosure is to provide a method for manufacturing a copper alloy wire which is capable of manufacturing a copper alloy wire having a good balance of strength and elongation with high productivity.

### [Advantageous Effects of the Present Disclosure]

The copper alloy wire according to the present disclosure has a good balance of strength and elongation. The method for manufacturing a copper alloy wire according to the present disclosure is capable of manufacturing a copper alloy wire having a good balance of strength and elongation with high productivity.

### DESCRIPTION OF EMBODIMENTS

First, embodiments of the present disclosure will be enumerated.

(1) A copper alloy wire according to an aspect of the present disclosure is a wire rod formed of a copper alloy and having
a tensile strength of 400 MPa or more,
an elongation at break of 5% or more,
a conductivity of 60% IACS or more, and
a wire diameter of 0.5 mm or less, wherein
the copper alloy has a composition containing 0.05% by mass or more and 1.6% by mass or less of iron, 0.01% by mass or more and 0.7% by mass or less of phosphorus, and 0.05% by mass or more and 0.7% by mass or less of tin with the balance being copper and unavoidable impurities,
the copper alloy has a structure containing crystals, and
a crystal grain size difference determined as a difference between a maximum crystal grain size and a minimum crystal grain size in a cross-section is 1.0 μm or less.

The cross-section herein refers to a section obtained by cutting an elongated material such as a copper alloy wire or an extruded material described later by a plane orthogonal to the longitudinal direction of the elongated material.

The wire diameter herein refers to the diameter of a circle having the same area as the cross-sectional area of a copper alloy wire. The cross-sectional area of a copper alloy wire refers to the area of cross-section of a copper alloy wire.

A structure whose crystal grain size difference described above is 1.0 μm or less is more uniform in crystal size as compared to a structure whose crystal grain size difference described above is more than 1.0 μm. The copper alloy wire according to the present disclosure has a structure containing crystals uniform in size, and therefore a reduction in mechanical properties resulting from variations in crystal size is less likely to occur as compared to a copper alloy wire having the above-described structure containing crystals non-uniform in size. Therefore, the copper alloy wire according to the present disclosure has a good balance of high tensile strength and high elongation at break. For this reason, the copper alloy wire according to the present disclosure has a good balance of strength and elongation. Further, the copper alloy wire according to the present disclosure has a conductivity of 60% IACS or more. Such a copper alloy wire according to the present disclosure can suitably be used for a conductor of a covered wire.

Further, the copper alloy wire according to the present disclosure can be manufactured with high productivity by a method for manufacturing a copper alloy wire according to the present disclosure described later. For this reason, the copper alloy wire according to the present disclosure is excellent also in manufacturability.

(2) In the copper alloy wire according to the above (1), the composition of the copper alloy may contain less than 0.001% by mass of carbon.

As described above, the copper alloy wire has high tensile strength even when it contains substantially no carbon. In a manufacturing process, carbon is not necessary as a raw material of the copper alloy wire. Therefore, the copper alloy wire is more excellent in manufacturability because a carbon-adding step or the like is not necessary.

(3) In the copper alloy wire according to the above (1) or (2), a content ratio by mass of iron to phosphorus may be 1.0 or more and 30 or less.

When the content ratio is 1.0 or more, the copper alloy wire is excellent in strength. When the content ratio is 30 or less, a reduction in the mechanical properties of the copper alloy wire resulting from variations in crystal size is less likely to occur.

(4) The copper alloy wire according to any of the above (1) to (3) may have a work hardening coefficient of 0.1 or more.

When having a work hardening coefficient of 0.1 or more, the copper alloy wire is easily work-hardened and is therefore suitable for a conductor of a covered wire with terminal described later.

(5) A covered wire according to an aspect of the present disclosure includes a conductor and an insulating layer covering a periphery of the conductor, wherein the conductor includes a copper alloy stranded wire, and the copper alloy stranded wire includes the copper alloy wire according to any of the above (1) to (4).

Since including the copper alloy wire according to the present disclosure, the copper alloy stranded wire has a good balance of strength and elongation. Further, the copper alloy stranded wire is more excellent also in resistance to repeated bending and resistance to impact as compared to a single copper alloy wire. Further, since including the copper alloy wire according to the present disclosure, the copper alloy stranded wire is excellent also in conductivity. Such a copper alloy stranded wire as described above can suitably be used for a conductor of a covered wire.

Since including the copper alloy stranded wire as a conductor, the covered wire according to the present disclosure has a good balance of strength and elongation. Further, the covered wire according to the present disclosure is excellent also in resistance to repeated bending and resistance to impact. Further, since including the copper alloy stranded wire as a conductor, the covered wire according to the present disclosure is excellent also in conductivity.

(6) A covered wire with terminal according to an aspect of the present disclosure includes the covered wire according to the above (5) and a terminal attached to at least one of ends of the covered wire.

Since including the copper alloy stranded wire as a conductor of the covered wire, the covered wire with terminal according to the present disclosure has a good balance of strength and elongation. Further, the covered wire with terminal according to the present disclosure is excellent also in resistance to repeated bending and resistance to impact. Further, since including the copper alloy stranded wire as a conductor of the covered wire, the covered wire with terminal according to the present disclosure is excellent also in conductivity.

(7) A method for manufacturing a copper alloy wire according to an aspect of the present disclosure includes:
a first step of manufacturing a casting material formed of a copper alloy by continuous casting;
a second step of subjecting the casting material to conform extrusion to manufacture a linear extruded material;
a third step of subjecting the extruded material to wire drawing to manufacture a drawn wire material; and
a fourth step of subjecting the drawn wire material to heat treatment to manufacture a heat-treated material, wherein
the copper alloy has a composition containing 0.05% by mass or more and 1.6% by mass or less of iron, 0.01% by mass or more and 0.7% by mass or less of phosphorus, and 0.05% by mass or more and 0.7% by mass or less of tin with the balance being copper and unavoidable impurities,
a reduction of area by the conform extrusion is 50% or more,
a temperature of the extruded material just after conform extrusion is 350° C. or more, and
a temperature of the heat treatment is 350° C. or more.

The reduction of area by conform extrusion herein refers to a ratio determined by dividing a difference between the cross-sectional area of the casting material and the cross-sectional area of the extruded material by the cross-sectional area of the casting material, and the ratio is expressed in percentage (%). The cross-sectional area of the casting material refers to the area of cross-section of the casting material. The cross-sectional area of the extruded material refers to the area of cross-section of the extruded material.

The temperature of the extruded material just after conform extrusion herein means the surface temperature of the extruded material at a point described below. The point is located 50 mm away from the outlet of the extruded material in a conform extruder in the longitudinal direction of the extruded material.

The method for manufacturing a copper alloy wire according to the present disclosure is capable of manufacturing a copper alloy wire having a good balance of strength and elongation. Further, the manufactured copper alloy wire is excellent also in conductivity. One of the reasons for this is that the method for manufacturing a copper alloy wire according to the present disclosure is capable of reducing variations in crystal size of the structure of a copper alloy constituting a copper alloy wire. Quantitatively, the method for manufacturing a copper alloy wire according to the present disclosure is capable of manufacturing a copper alloy wire having a tensile strength of 400 MPa or more, an elongation at break of 5% or more, and a crystal grain size difference described above of 1.0 μm or less. Further, the copper alloy wire has a conductivity of 60% IACS or more. In the method for manufacturing a copper alloy wire according to the present disclosure, a casting speed (m/min) in the first step can be made relatively high. When the casting speed is higher, a casting material is more efficiently manufactured in mass quantities. In the second step, a long extruded material can be manufactured. That is, an extruded material can also be manufactured in mass quantities. In the third step, as described later, wire breakage is less likely to occur during wire drawing. That is, a drawn wire material can also be manufactured in mass quantities. In the fourth step, a temperature range usable for heat treatment is as relatively wide as 350° C. or more. This makes it easy to control heat treatment conditions. For these reasons, the method for manufacturing a copper alloy wire according to the present disclosure is capable of manufacturing a copper alloy wire having a good balance of strength and elongation with high productivity.

The method for manufacturing a copper alloy wire according to the present disclosure is based on findings described below.

In a case where a casting material formed of the above-described copper alloy having a specific composition is manufactured by continuous casting, a compound containing iron and phosphorus is more likely to unevenly be distributed in the casting material when a casting speed (m/min) is higher. When such a casting material is subjected to wire drawing and then a manufactured drawn wire material is subjected to heat treatment, the compound may unusually grow. That is, the structure after heat treatment may be not a structure in which small particles of the compound are dispersed but a structure in which coarse particles of the compound are included and unevenly distributed. In such a structure after heat treatment, coarse crystals may locally be generated. That is, the structure after heat treatment has large variations in crystal size. Such coarse crystals may cause a reduction in mechanical properties, especially elongation.

On the other hand, when the casting material is subjected to conform extrusion that achieves a specific reduction of area and then a manufactured extruded material is subjected to specific heat treatment, the structure after heat treatment has small variations in crystal size. The reason for this can be considered as follows. Extrusion pressure and processing heat are applied to the casting material by the conform extrusion that achieves a specific reduction of area. Such application of pressure and heat breaks a cast structure. Even when the casting speed is high, the cast structure is broken. The breakage of the cast structure allows the compound to be dispersed as small particles in the structure. Even when an extruded material having such a structure is subjected to wire drawing and then a manufactured drawn wire material is subjected to heat treatment, coarse crystal grains may be prevented from being locally generated. That is, the structure after heat treatment is a structure containing crystals uniform in size.

### Details of Embodiments of the Present Disclosure

Hereinbelow, embodiments of the present disclosure will be described in detail with reference to the drawings as appropriate. In the drawings, identical reference signs denote identically named components.

### [Copper Alloy Wire]

### (Outline)

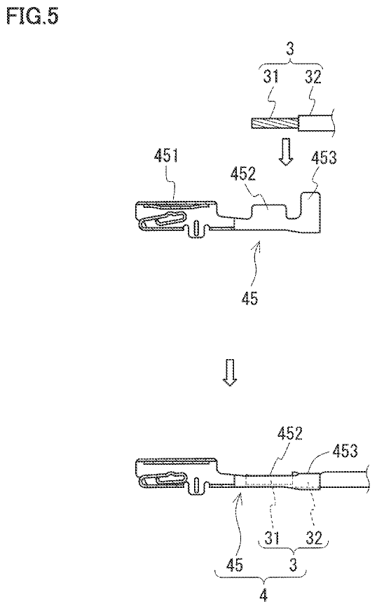

A copper alloy wire 1 according to an embodiment is a thin wire rod formed of a copper alloy. The copper alloy has a composition containing, when the amount of the copper alloy is taken as 100% by mass, 0.05% by mass or more and 1.6% by mass or less of iron, 0.01% by mass or more and 0.7% by mass or less of phosphorus, and 0.05% by mass or more and 0.7% by mass or less of tin with the balance being copper and unavoidable impurities. As shown in FIG. 7, the copper alloy has a structure containing crystals 11. Particularly, copper alloy wire 1 according to the embodiment has a crystal grain size difference of 1.0 μm or less as determined as a difference between a maximum crystal grain size and a minimum crystal grain size in a cross-section. As described later, copper alloy wire 1 according to the embodiment having the above-described specific composition and structure has a good balance of strength and elongation. Further, copper alloy wire 1 according to the embodiment is excellent also in conductivity. Such copper alloy wire 1 according to the embodiment can suitably be used for a conductor 31 of such a covered wire 3 as shown in FIG. 4 and FIG. 5.

Hereinbelow, the composition of the copper alloy, the structure of the copper alloy, a wire diameter, and properties will be described in order.

In the following description, elements may be represented by their atomic symbols. Cu means copper. Fe means iron. P means phosphorus. Sn means tin.

### (Composition)

The copper alloy constituting copper alloy wire 1 according to the embodiment is a copper-based alloy containing copper in the largest amount and containing, as additive elements, iron, phosphorus, and tin in amounts within the above ranges.

### <Iron>

When the content of iron is 0.05% by mass or more, a compound of iron and phosphorus is formed. When the compound is precipitated in copper as a parent phase, the effect of improving strength is obtained due to precipitation strengthening. Further, when the compound is formed, the amounts of iron and phosphorus solid-dissolved in copper are reduced. For these reasons, copper alloy wire 1 is excellent in conductivity as well as strength. When the content of iron is 1.6% by mass or less, a structure in which small particles of the compound are dispersed can be obtained. Therefore, as shown in FIG. 7, copper alloy wire 1 has a structure containing crystals 11 having small variations in size, that is, a structure containing crystals 11 uniform in size. For this reason, copper alloy wire 1 is excellent also in elongation. In a manufacturing process, the occurrence of wire breakage resulting from the compound is reduced. For this reason, copper alloy wire 1 is excellent also in manufacturability.

The content of iron may be 0.08% by mass or more and 1.5% by mass or less, 0.09% by mass or more and 1.2% by mass or less, or 0.1% by mass or more and 1.0% by mass or less. Such copper alloy wire 1 has a good balance of strength and elongation and is excellent also in manufacturability as well as conductivity.

### <Phosphorus>

When the content of phosphorus is 0.01% by mass or more, a compound of iron and phosphorus is formed. As described above, the compound makes it possible to obtain the effect of improving strength due to precipitation strengthening and the effect of reducing the solid-solution amounts of phosphorus and iron. When the content of phosphorus is 0.7% by mass or less, a structure in which small particles of the compound are dispersed is obtained. Therefore, as described above, crystals 11 have small variations in size. Further, in a manufacturing process, the occurrence of wire breakage resulting from the compound is reduced. It should be noted that part of phosphorus is allowed to function as a deoxidant, that is, to be contained as phosphorus oxide in the parent phase.

The content of phosphorus may be 0.02% by mass or more and 0.6% by mass or less, 0.03% by mass or more and 0.5% by mass or less, or 0.05% by mass or more and 0.4% by mass or less. Such copper alloy wire 1 has a good balance of strength and elongation and is excellent also in manufacturability as well as conductivity.

### <Fe/P>

The content ratio by mass of iron to phosphorus, Fe/P may be 1.0 or more and 30 or less. When Fe/P is larger, the effect of improving strength due to precipitation strengthening is more satisfactorily obtained. When Fe/P is 2.0 or more, conductivity as well as strength tends to improve. When Fe/P is 30 or less, iron is prevented from becoming a coarse precipitate. This makes it possible to obtain a structure in which small particles of a precipitate containing the above-described compound are dispersed. Therefore, variations in crystal size are prevented. In a manufacturing process, the occurrence of wire breakage resulting from the above-described precipitate is reduced. From the viewpoint of improving strength, conductivity, productivity, and the like, Fe/P may be 2.0 or more and 20 or less, 2.2 or more and 20 or less, or 3.0 or more and 15 or less.

### <Tin>

When the content of tin is 0.05% by mass or more, the effect of improving strength is obtained due to solid-solution strengthening by tin. When the content of tin is 0.7% by mass or less, a reduction in conductivity resulting from excessive solid-solution of tin is prevented. Further, a reduction in plastic formability resulting from excessive solid-solution of tin is prevented. Therefore, in a manufacturing process, for example, plastic forming such as conform extrusion or wire drawing can satisfactorily be performed.

The content of tin may be 0.05% by mass or more and 0.6% by mass or less, 0.05% by mass or more and 0.5% by mass or less, or 0.1% by mass or more and 0.5% by mass or less. Such copper alloy wire 1 has a good balance of strength and elongation and is excellent also in manufacturability as well as conductivity.

### <Other Elements>

The copper alloy constituting copper alloy wire 1 according to the embodiment may have a composition containing 0.001% by mass or more and 0.05% by mass or less of carbon. Carbon has a deoxidation effect on iron, phosphorus, and tin. When the copper alloy contains carbon in an amount within the above range, the deoxidation effect facilitates formation of a compound from iron and phosphorus and forming a solid solution of tin in copper. The content of carbon may be 0.001% by mass or more and 0.03% by mass or less or 0.003% by mass or more and 0.015% by mass or less.

On the other hand, the copper alloy constituting copper alloy wire 1 according to the embodiment may have a composition containing substantially no carbon. Quantitatively, the composition of the copper alloy may contain less than 0.001% by mass of carbon. Even in such a case, copper alloy wire 1 according to the embodiment has a good balance of strength and elongation and is excellent also in conductivity. When the content is less than 0.001% by mass, carbon is not necessary as a raw material of copper alloy wire 1 in a manufacturing process. Therefore, copper alloy wire 1 is excellent in manufacturability because a carbon-adding step or the like is not necessary. The cost of raw materials is also reduced.

### (Structure)

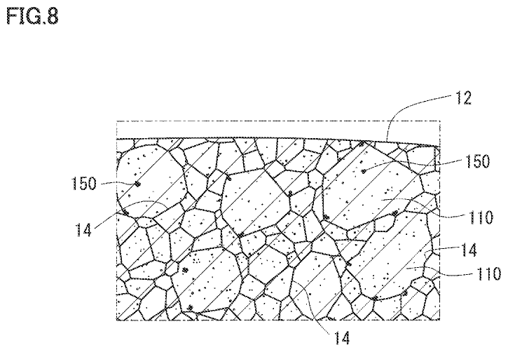

As shown in FIG. 7, the copper alloy constituting copper alloy wire 1 according to the embodiment has a structure containing crystals 11 and a compound 15. Crystals 11 mainly contain copper. Compound 15 contains iron and phosphorus. In the above-described structure, crystals 11 have small variations in size. Further, in the above-described structure, relatively small particles of compound 15 are evenly dispersed. In FIG. 7, compound 15 is shown as particles represented by black dots, and in FIG. 8 described later, a coarse compound 150 is shown as particles represented by black dots.

### <Crystal Grain Size Difference>

Quantitatively, copper alloy wire 1 has a crystal grain size difference of 1.0 μm or less in its cross-section. When the crystal grain size difference is 1.0 μm or less, crystals 11 are more uniform in size as compared to a case where the crystal grain size difference is more than 1.0 μm. Copper alloy wire 1 contains substantially no coarse crystals 110 shown in FIG. 8. Therefore, a reduction in mechanical properties, especially a reduction in elongation, resulting from coarse crystals 110 is prevented. Further, breakage is prevented which is caused by coarse crystals 110 as starting points of cracking. A reduction in tensile strength resulting from the breakage, a reduction in resistance to repeated bending, a reduction in resistance to impact and the like are also prevented. For these reasons, copper alloy wire 1 according to the embodiment has a good balance of strength and elongation. From the viewpoint of preventing a reduction in mechanical properties and from a similar viewpoint, the crystal grain size difference may be 0.9 μm or less, 0.8 μm or less, or 0.7 μm or less.

The lower limit of the crystal grain size difference is ideally zero. However, when the crystal grain size difference is, for example, 0.1 μm or more, manufacturing conditions of copper alloy wire 1 are easily controlled. From the viewpoint of preventing a reduction in mechanical properties and improving productivity, the crystal grain size difference may be 0.1 μm or more and 1.0 μm or less, 0.1 μm or more and 0.9 μm or less, or 0.2 μm or more and 0.8 μm or less.

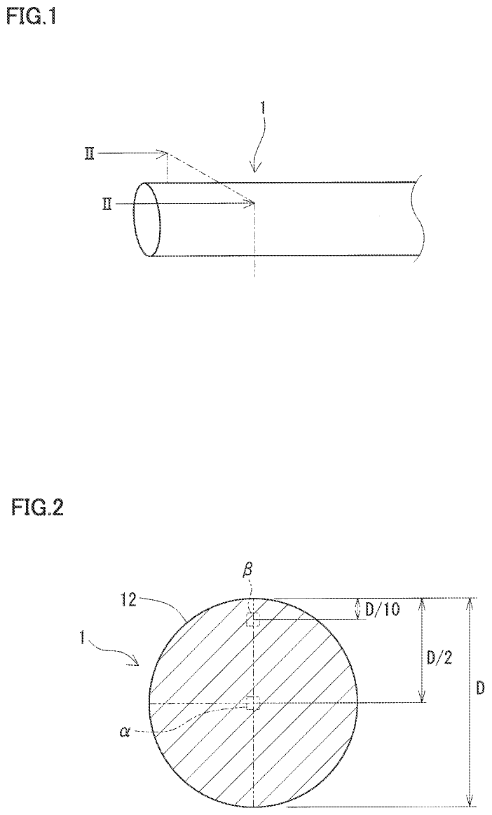

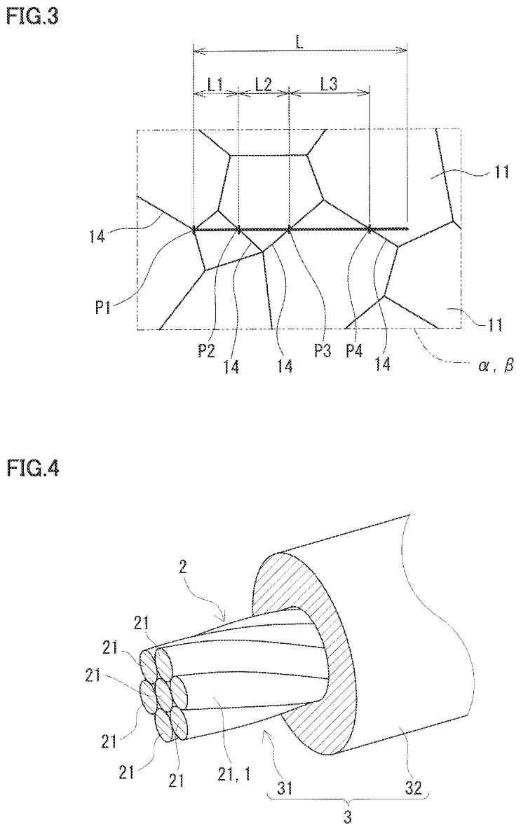

With reference to FIG. 2 and FIG. 3, a method for measuring the crystal grain size difference will be described hereinbelow. Copper alloy wire 1 is placed at any position to take a cross—The section. The cross-section is observed with a scanning electron microscope (SEM). magnification of observation is, for example, 1,000 times or more and 50,000 times or less.

As shown in FIG. 2, two fields of view a and B are taken from the cross-section. Each of fields of view α and β has a rectangular shape and a size of 25 μm×15 μm. Field of view a is taken from the central region of the cross-section. Field of view β is taken from a region near the periphery of the cross-section. The central region is a region including a point a half of a wire diameter D of copper alloy wire 1, that is, wire diameter D/2 away from an edge 12 of copper alloy wire 1 shown in the cross-section. The region near the periphery is a region including a point wire diameter D/10 away from edge 12. When copper alloy wire 1 is a round wire, the “point wire diameter D/2 away from edge 12” is the center of a circle drawn by edge 12. The “point wire diameter D/10 away from edge 12” is a point on the circumference of a circle whose center is the same as the circle drawn by edge 12 and whose radius is 0.4× D.

As shown in FIG. 3, a straight line is drawn to be parallel to the long side of each of fields of view α and B. In FIG. 3, the straight line is shown by a thick solid line. In field of view a, the straight line is drawn to pass through the “point wire diameter D/2 away”. In field of view B, the straight line is drawn to pass through the “point wire diameter D/10 away”. The straight line has a length L of 15 μm. The intersection point of the straight line and a crystal grain boundary 14 is taken. In FIG. 3, intersection points P1, P2, P3, and P4 are shown as examples. The length between adjacent intersection points is measured along the straight line. In FIG. 3, a length L1 between intersection points P1 and P2, a length L2 between intersection points P2 and P3, and a length L3 between intersection points P3 and P4 are measured. The length between adjacent intersection points is defined as a crystal grain size. In each of fields of view α and B, a maximum crystal grain size and a minimum crystal grain size are determined, and (maximum grain size-minimum grain size)/2 is further determined by dividing a difference between the maximum grain size and the minimum grain size by 2. The crystal grain size difference is determined as an average of two values determined, that is, {(maximum grain size-minimum grain size) of field of view a/2+ (maximum grain size-minimum grain size) of field of view β/2}/2. It should be noted that in FIG. 2 and FIG. 3, fields of view α and β are virtually shown by a dash-dot-dot line. In FIG. 3, hatching is omitted.

### (Wire Diameter)

Wire diameter D of copper alloy wire 1 according to the embodiment is 0.5 mm or less. Such copper alloy wire 1 is typically manufactured through the step of subjecting the above-described thick material to wire drawing to achieve a wire diameter of 0.5 mm or less. When wire diameter D is 0.5 mm or less, the effect of improving strength is obtained due to work hardening caused by wire drawing in a manufacturing process. For this reason, copper alloy wire 1 can have high strength. Wire diameter D can appropriately be selected depending on the intended use of copper alloy wire 1. Wire diameter D may be 0.4 mm or less. 0.35 mm or less, or 0.3 mm or less. The lower limit of wire diameter D is not set. However, when wire diameter D is, for example, 0.01 mm or more, manufacturing conditions of copper alloy wire 1 are easily controlled. From the viewpoint of improving strength and productivity, wire diameter D may be 0.01 mm or more and 0.5 mm or less, 0.05 mm or more and 0.4 mm or less, or 0.1 mm or more and 0.35 mm or less.

### (Shape)

The cross-sectional shape of copper alloy wire 1 according to the embodiment is not limited. A typical example of copper alloy wire 1 is a round wire having a circular cross-sectional shape. FIG. 1 and FIG. 2 illustrate a case where copper alloy wire 1 is a round wire. The cross-sectional shape may be, for example, a quadrangular shape such as a rectangular shape, a polygonal shape such as a hexagonal shape, or a curved surface shape such as an elliptical shape. It should be noted that when copper alloy wire 1 is a round wire, wire diameter D is the diameter of this circle.

### (Properties)

### <Tensile Strength>

Copper alloy wire 1 according to the embodiment has a tensile strength of 400 MPa or more. For this reason, copper alloy wire 1 according to the embodiment is excellent in strength. From the viewpoint of improving strength, the tensile strength may be 410 MPa or more, 430 MPa or more, or 450 MPa or more.

The upper limit of the tensile strength is not limited. However, when the tensile strength is higher, elongation at break and conductivity tend to be lower. From the viewpoint of a balance between strength and elongation and good conductivity, the tensile strength may be 800 MPa or less, 780 MPa or less, or 750 MPa or less.

When the tensile strength is 400 MPa or more and 800 MPa or less, 420 MPa or more and 780 MPa or less, 430 MPa or more and 750 MPa or less, copper alloy wire 1 is excellent in conductivity as well as a balance between strength and elongation.

The tensile strength and elongation at break and work hardening coefficient described later are measured by performing a tensile test in accordance with JIS Z 2241:2011.

### <Elongation at Break>

Copper alloy wire 1 according to the embodiment has an elongation at break of 5% or more. For this reason, copper alloy wire 1 according to the embodiment is excellent in elongation. From the viewpoint of improving elongation, the elongation at break may be 6% or more, 8% or more, or 10% or more.

The upper limit of the elongation at break is not limited. However, when the elongation at break is higher, the tensile strength tends to be lower. From the viewpoint of a balance between strength and elongation, the elongation at break may be 30% or less, 25% or less, or 20% or less.

When the elongation at break is 5% or more and 30% or less, 6% or more and 25% or less, or 10% or more and 20% or less, copper alloy wire 1 is excellent in balance between strength and elongation.

### <Conductivity>

Copper alloy wire 1 according to the embodiment has a conductivity of 60% IACS or more. For this reason, copper alloy wire 1 according to the embodiment is excellent in conductivity. From the viewpoint of improving conductivity, the conductivity may be 61% IACS or more, 62% IACS or more, or 65% IACS or more.

The upper limit of the conductivity is not limited. However, when the conductivity is higher, the tensile strength tends to be lower. From the viewpoint of satisfactory strength and conductivity, the conductivity may be 95% IACS or less, 90% IACS or less, or 85% IACS or less.

When the conductivity is 60% IACS or more and 95% IACS or less, 61% IACS or more and 90% IACS or less, 65% IACS or more and 85% IACS or less, copper alloy wire 1 is excellent in conductivity as well as strength.

The conductivity is measured by a four-terminal method. Specifically, the resistance value of a copper alloy wire having a length of 1 m is measured in accordance with JASO D618. The conductivity can be determined as the reciprocal of the resistance value. The resistance value can be measured using a commercially-available device.

### <Work Hardening Coefficient>

Copper alloy wire 1 according to the embodiment has a work hardening coefficient of, for example, 0.1 or more. The work hardening coefficient is defined as an exponent n of true strain & in an expression described below. The expression is σ=C×εⁿ wherein σ is true stress and ε is true strain in a plastic strain region at the time when a load in a tensile test is applied to a uniaxial direction, and C is a strength parameter. The exponent n is determined by performing the above-described tensile test to prepare an S-S curve. If necessary, JIS G 2253:2011 can be referred to for a test method for work hardening coefficient.

When the work hardening coefficient is higher, copper alloy wire 1 is more easily work-hardened. When such copper alloy wire 1 is used for conductor 31 of a covered wire with terminal 4 shown in FIG. 5, it is expected that a portion of conductor 31 where a terminal 45 is attached maintains strength comparable to that of a portion of conductor 31 where terminal 45 is not attached. For this reason, the work hardening coefficient may be 0.11 or more, 0.12 or more, or 0.13 or more.

### [Intended Use of Copper Alloy Wire]

Copper alloy wire 1 according to the embodiment is used for, for example, conductor 31. Conductor 31 may be constituted from copper alloy wire 1 as a single wire or an assembly of copper alloy wires 1. The assembly is, for example, a stranded wire.

### [Copper Alloy Stranded Wire]

As shown in FIG. 4, a copper alloy stranded wire 2 according to an embodiment is formed by stranding a plurality of elemental wires 21. At least one of elemental wires 21 is copper alloy wire 1 according to the embodiment. Copper alloy stranded wire 2 includes copper alloy wire 1 according to the embodiment as elemental wire 21 and therefore has excellent conductivity as well as a good balance of strength and elongation. When all elemental wires 21 are copper alloy wires 1 according to the embodiment, copper alloy stranded wire 2 has excellent conductivity as well as a good balance of strength and elongation. It should be noted that copper alloy wire 1 used as elemental wire 21 substantially maintains the tensile strength, elongation at break, and conductivity of copper alloy wire 1 according to the embodiment even after stranding.

FIG. 4 illustrates copper alloy stranded wire 2 formed by concentrically stranding seven elemental wires 21. The number of elemental wires 21 and a stranding method are not limited. Copper alloy stranded wire 2 may be a compression stranded wire not shown. The compression stranded wire is manufactured by stranding a plurality of elemental wires 21 and then compressing a resultant stranded wire. The compression stranded wire has a smaller cross-sectional area, a smaller wire diameter, and a cross-sectional shape nearer to a circle as compared to uncompressed copper alloy stranded wire 2 shown in FIG. 4.

### [Covered Wire]

As shown in FIG. 4, a covered wire 3 according to an embodiment includes a conductor 31 and an insulating layer 32. Insulating layer 32 covers the periphery of conductor 31. In an example of covered wire 3 according to the embodiment, conductor 31 is copper alloy stranded wire 2 according to the embodiment. In another example of the covered wire 3 according to the embodiment, conductor 31 is copper alloy wire 1 according to the embodiment as a single wire. Another example is not shown. Covered wire 3 according to the embodiment includes copper alloy wire 1 according to the embodiment as conductor 31 and therefore has excellent conductivity as well as a good balance of strength and elongation.

It should be noted that the sectional area and wire diameter of conductor 31, the constituent material and thickness of insulating layer 32, and the like are not limited. The constituent material of insulating layer 32 is a known material such as polyvinyl chloride (PVC), a halogen-free resin, or a flame-resistant material. The halogen-free resin is, for example, polypropylene (PP).

[Covered Wire with Terminal]

As shown in FIG. 5, a covered wire with terminal 4 according to an embodiment includes covered wire 3 according to the embodiment and a terminal 45. Terminal 45 is attached to at least one of ends of covered wire 3. Covered wire with terminal 4 according to the embodiment includes covered wire 3 according to the embodiment and therefore has excellent conductivity as well as a good balance of strength and elongation.

In FIG. 5, a female terminal is shown as an example of terminal 45. This female terminal includes a connecting part 451, a wire barrel part 452, and an insulation barrel part 453.

Connecting part 451 is electrically connected to a male terminal not shown. In FIG. 5, only connecting part 451 is shown in a sectional view obtained by cutting connecting part 451 by a plane parallel to the longitudinal direction of covered wire 3. Wire barrel part 452 holds conductor 31. Insulation barrel part 453 holds insulating layer 32.

Terminal 45 is not limited. Terminal 45 may be a male terminal, a crimp terminal, or the like not shown. Terminal 45 may be one to which a plurality of covered wires 3 can be attached.

### [Method for Manufacturing Copper Alloy Wire]

Copper alloy wire 1 according to the embodiment can be manufactured by, for example, a method for manufacturing a copper alloy wire according to an embodiment described below. The method for manufacturing a copper alloy wire according to the embodiment includes a first step, a second step, a third step, and a fourth step described below and satisfies three conditions described below.

The first step is a step of manufacturing a casting material formed of a copper alloy by continuous casting. The copper alloy has a composition containing iron, phosphorus, and tin in amounts within the above-described specific ranges with the balance being copper and unavoidable impurities. The details of composition of the copper alloy are as described above.

The second step is a step of subjecting the casting material to conform extrusion to manufacture a linear extruded material.

The third step is a step of subjecting the extruded material to wire drawing to manufacture a drawn wire material.

The fourth step is a step of subjecting the drawn wire material to heat treatment to manufacture a heat-treated material.

### <Conditions>

«Reduction of area» The reduction of area by the conform extrusion is 50% or more.
«Extrusion temperature» The temperature of the extruded material just after conform extrusion is 350° C. or more.
«Heat treatment temperature» The temperature of the heat treatment is 350° C. or more.

The method for manufacturing a copper alloy wire according to the embodiment uses, as a material to be subjected to wire drawing, an extruded material manufactured by subjecting a casting material to conform extrusion performed under the above-described specific conditions. Therefore, the method for manufacturing a copper alloy wire according to the embodiment is capable of manufacturing copper alloy wire 1 having excellent conductivity as well as a good balance of strength and elongation with high productivity for reasons<1> to <4> described below. The above-described heat-treated material is an example of copper alloy wire 1 according to the embodiment.
<1> A casting speed (m/min) can be made relatively high. For this reason, a casting material can be manufactured in mass quantities.
<2> The conform extrusion can manufacture a long extruded material. For this reason, an extruded material can also be manufactured in mass quantities.
<3> When the extruded material is subjected to wire drawing, wire breakage is less likely to occur during wire drawing. Further, the extruded material can continuously be subjected to wire drawing. For these reasons, a drawn wire material can also be manufactured in mass quantities.
<4> A temperature range usable for heat treatment is relatively wide. For this reason, heat treatment conditions can easily be controlled.

Hereinbelow, each of the steps will be described.

### <First Step>

The continuous casting may be performed using a known method such as an up-casting method, a vertical casting method, a horizontal casting method, a belt and wheel method, or a twin belt method. When a casting material is manufactured, a casting speed (m/min) or the like is adjusted. The casting speed (m/min) is the length of a casting material manufactured per minute. The casting speed is adjusted depending on, for example, the composition of a copper alloy, the size of a casting material, cooling conditions, and the conditions of intermittent drawing during casting. The casting speed can appropriately be selected. When the casting speed is, for example, more than 1.0 m/min or 1.2 m/min or more, the amount of a casting material manufactured per unit time is large. That is, a casting material is manufactured in mass quantities. For this reason, copper alloy wire 1 is manufactured with high productivity. The upper limit of the casting speed is, for example, 4.0 m/min.

The size of the casting material is adjusted so that the conform extrusion in the second step can achieve a reduction of area of 50% or more. The wire diameter of the casting material is, for example, 8 mm or more and 25 mm or less. The wire diameter of the casting material herein refers to the diameter of a circle having the same area as the cross-section of the casting material.

The casting material is, for example, a round wire having a circular cross-section. The casting material may be, for example, a square wire having a rectangular cross-section as long as it can be subjected to conform extrusion.

### <Second Step>

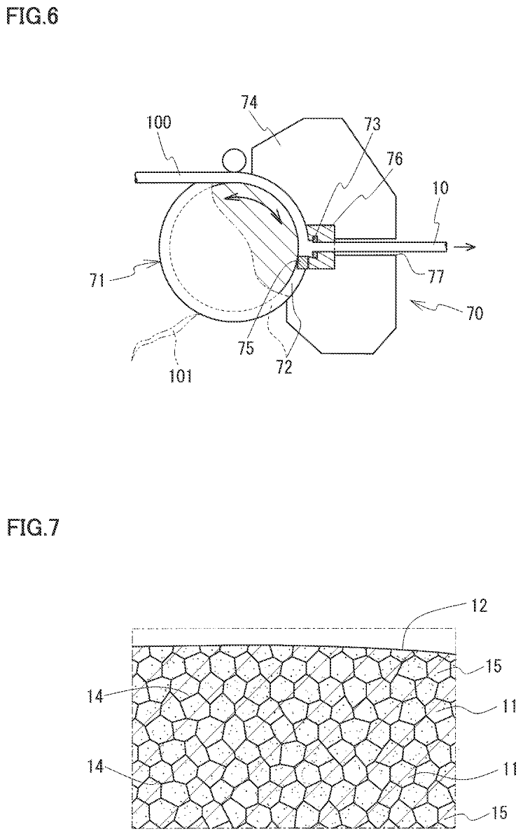

The conform extrusion can be performed using a known conform extruder. With reference to FIG. 6, the outline of a conform extruder 70 will be described hereinbelow. Conform extruder 70 includes a wheel 71, a die 73, a shoe 74, and an abutment 75. Wheel 71 is a rotatably-supported disk. Wheel 71 has a circumferential surface having a recessed groove 72. Recessed groove 72 is an annular groove provided along the circumferential direction of wheel 71. Recessed groove 72 is open on the circumferential surface of wheel 71. Shoe 74 is disposed to be opposed to wheel 71. Shoe 74 covers part of the opening of recessed groove 72 along the circumferential direction of wheel 71. Shoe 74 does not cover the rest of the opening. Abutment 75 has a convex part. The convex part is inserted in a predetermined position in part of recessed groove 72 covered with shoe 74. As shown in FIG. 6, the convex part blocks part of recessed groove 72. A material 100 is introduced into a space surrounded by recessed groove 72, shoe 74, and the convex part. Die 73 pushes out material 100 accumulated in the space. Die 73 is held by a die chamber 76.

When inserted into recessed groove 72 of wheel 71 that is rotating, material 100 is sequentially drawn into the above-described space by the frictional force between wheel 71 and material 100. Material 100 drawn into the space is substantially trapped in the space so that extrusion pressure is generated in material 100. This extrusion pressure allows material 100 to be sequentially drawn into the space. Material 100 that has flowed into the space is extruded by die 73 into a predetermined shape. As a result, an extruded material 10 is manufactured. Extruded material 10 is discharged through the outlet of an extruded material in conform extruder 70 which herein corresponds to an opening 77 of shoe 74. It should be noted that during extrusion, dust 101 is discharged from between wheel 71 and abutment 75. Dust 101 is removed by being cut with a scraper not shown.

### «Reduction of Area»

The reduction of area by conform extrusion is 50% or more. The reduction of area is a ratio determined by dividing a difference between the cross-sectional area of the casting material corresponding to material 100 and the cross-sectional area of extruded material 10 by the cross-sectional area of the casting material. During conform extrusion, the above-described extrusion pressure and processing heat resulting from the above-described friction are applied to the casting material corresponding to material 100. When the reduction of area is 50% or more, higher extrusion pressure and higher processing heat are applied to the casting material as compared to a case where the reduction of area is less than 50%. Such application of pressure and heat breaks a cast structure. Specifically, crystals constituting extruded material 10 become smaller than crystals constituting the casting material. Further, arrangement of crystals also changes. Further, particles of the above-described compound containing iron and phosphorus become relatively small and are precipitated in extruded material 10 so as to be uniformly dispersed. That is, the size and arrangement of crystals in the structure of extruded material 10 after extrusion are different from those in the structure of the casting material before extrusion, and the compound is dispersed as small particles. Since extruded material 10 to be subjected to wire drawing has such a structure, even when the drawn wire material after wire drawing is subjected to heat treatment, the heat-treated material is less likely to have variations in crystal size. Further, since particles of the compound in extruded material 10 are small, the compound is less likely to become a starting point of cracking during wire drawing. Therefore, when extruded material 10 is subjected to wire drawing in such a manner that the direction of wire drawing is parallel to the direction of extrusion, wire breakage is less likely to occur during wire drawing.

When the reduction of area is higher, the extrusion pressure and the processing heat are likely to become higher. Therefore, the cast structure is satisfactorily broken. Finally, the heat-treated material is likely to have smaller variations in crystal size. Further, wire breakage is less likely to occur during wire drawing. For these reasons, the reduction of area may be 55% or more, 60% or more, or 70% or more.

The upper limit of the reduction of area is not set. For example, the reduction of area may be 50% or more and 99% or less, 55% or more and 95% or less, or 60% or more and 90% or less.

### «Wire Diameter of Extruded Material»

The size of extruded material 10 is adjusted so that the above-described reduction of area is 50% or more. The wire diameter of extruded material 10 is, for example, 2.5 mm or more and less than 9.5 mm. The cross-sectional area and wire diameter of the casting material and the area and diameter of opening of die 73 are adjusted so that extruded material 10 has a predetermined wire diameter. The area and diameter of opening of die 73 respectively correspond to the cross-sectional area and wire diameter of extruded material 10.

### «Temperature»

As described above, the casting material is heated by processing heat during conform extrusion. Such heating increases the plastic formability of the casting material. Further, such heating allows the compound to be precipitated. When the temperature of extruded material 10 just after conform extrusion is 350° C. or more, the effect of improving plastic formability is likely to satisfactorily be obtained and the compound is likely to appropriately be precipitated. The temperature may be 350° C. or more and 550° C. or less, 380° C. or more and 500° C. or less, or 400° C. or more and 500° C. or less. An extrusion speed is adjusted depending on, for example, the composition of the copper alloy and the reduction of area so that the temperature is 350° C. or more. The temperature may be adjusted by, for example, heating material 100 or heating or cooling a member constituting conform extruder 70, such as die 73. The temperature of extruded material 10 just after conform extrusion is a surface temperature at a point in extruded material 10 described below. The point is a point 50 mm away from opening 77 of shoe 74, which is the outlet of extruded material 10 in conform extruder 70, in the longitudinal direction of extruded material 10.

It should be noted that conform extrusion may directly be performed on the casting material or may be performed on a scalped material obtained by scalping the casting material.

### <Third Step>

In the third step, multi-pass wire drawing is typically performed so that a drawn wire material having a predetermined final wire diameter can be obtained. When wire drawing is performed by cold working, the compound is prevented from becoming coarse during wire drawing. Wire drawing is performed using, for example, a wire drawing die. The final wire diameter of the drawn wire material is adjusted depending on the wire diameter of copper alloy wire 1.

### <Fourth Step>

In the fourth step, heat treatment is performed at a temperature of 350° C. or more. Due to such heat treatment, a compound containing iron and phosphorus is precipitated or the size of a previously-precipitated compound is adjusted. Therefore, the effect of improving strength due to precipitation strengthening and the effect of improving conductivity due to reduction of solid-solution of iron and phosphorus are obtained. As described above, the structure before and after wire drawing contains a small amount of the coarse compound or contains substantially no coarse compound. Therefore, the compound is prevented from unusually growing even when heat treatment is performed. That is, even when heat treatment is performed, particles of the compound remain small in size and are dispersed. Therefore, variations in crystal size are reduced. Further, processing distortion caused by wire drawing in the third step is removed by heat treatment. That is, the effect of improving elongation is obtained also by softening. Therefore, a heat-treated material having excellent conductivity as well as a good balance of strength and elongation, that is, copper alloy wire 1 is manufactured.

When the temperature of heat treatment is higher, the effect of improving elongation due to softening is more likely to be obtained, but strength is more likely to reduce. Further, the compound may become coarse. From the viewpoint of a balance between strength and elongation, the temperature may be 350° C. or more and 550° C. or less, 380° C. or more and 530° C. or less, or 400° C. or more and 500° C. or less. The time during which the temperature is maintained is, for example, more than 4 hours and 40 hours or less or 5 hours or more and 20 hours or less.

[Methods for Manufacturing Copper Alloy Stranded Wire, Covered Wire, and Covered Wire with Terminal]

Copper alloy stranded wire 2, covered wire 3, and covered wire with terminal 4 according to the embodiments can be all manufactured with reference to known manufacturing methods. Therefore, a detailed description of methods for manufacturing them is omitted.

Hereinbelow, the effects of copper alloy wire 1 according to the embodiment and the method for manufacturing a copper alloy wire according to the embodiment will specifically be described with reference to a test example.

### Test Example 1

Copper alloy wires each formed of a copper alloy containing iron, phosphorus, and tin were manufactured by various manufacturing methods. The crystal grain size difference and properties of each of the manufactured copper alloy wires were examined. The compositions of the copper alloys and manufacturing conditions are shown in Table 1. The results of the examination are shown in Table 2.

### (Composition)

The copper alloy constituting each of the copper alloy wires prepared as samples has a composition shown in Table 1. The composition of each of the copper alloy wires prepared as samples can be examined by a known method of analysis. Examples of the method of analysis include inductively coupled plasma (ICP) emission spectrometry and fluorescent X-ray analysis.

### (Manufacturing Conditions)

Each of the copper alloy wires prepared as samples was manufactured by a manufacturing method including a type-A process or a type-B process described below. The copper alloy constituting a casting material described below has a composition containing iron, phosphorus, and tin with the balance being copper and unavoidable impurities. Specific compositions are as shown in Table 1.

### <Type-A Process>

The type-A process includes a first step, a second step, a third step, and a fourth step described below which are performed in order.

In the first step, a casting material formed of a copper alloy is manufactured by continuous casting.

In the second step, the casting material is subjected to conform extrusion.

In the third step, a manufactured extruded material is subjected to cold wire drawing.

In the fourth step, a manufactured drawn wire material is subjected to heat treatment.

In the Type-A process, a heat-treated material is manufactured as a copper alloy wire. The wire diameter (mm) of the heat-treated material is the wire diameter of the drawn wire material and is also the wire diameter (mm) of the copper alloy wire.

A casting speed in the first step is 1.4 m/min.

The reduction of area (%) by conform extrusion in the second step is as shown in Table 1.

In the third step, the extruded material having a wire diameter described below is subjected to wire drawing to achieve a wire diameter of ϕ0.16 mm, ϕ0.18 mm, or ϕ0.35 mm.

The temperature (° C.) of heat treatment and the time (h) during which the temperature is maintained in the fourth step are as shown in Table 1.

In the cases of Samples No. 1-1 to 1-6 and 1-101, the wire diameter of the casting material is ϕ12.5 mm and the wire diameter of the extruded material is ϕ8.0 mm. The temperature of these samples just after conform extrusion was 450° C.

In the cases of Samples No. 1-108 and 1-109, the wire diameter of the casting material is ϕ12.5 mm and the wire diameter of the extruded material is ϕ9.5 mm.

### <Type-B Process>

The type-B process includes steps described below which are performed in order. In the type-B process, conform extrusion is not performed.

First, a casting material formed of a copper alloy and having a wire diameter of ϕ12.5 mm is manufactured by continuous casting. Then, the casting material is subjected to cold rolling to manufacture a rolled material having a wire diameter of ϕ9.5 mm. Then, the rolled material is subjected to scalping to manufacture a wire rod having a wire diameter of ϕ8.0 mm. Then, the scalped wire rod is subjected to cold wire drawing to manufacture a drawn wire material having a wire diameter of ϕ0.16 mm or ϕ0.18 mm. Finally, the drawn wire material is subjected to heat treatment. Also in the type-B process, a heat-treated material is manufactured as a copper alloy wire.

A casting speed in the manufacture of a casting material is 1.0 m/min.

The temperature (° C.) of heat treatment and the time (h) during which the temperature is maintained are as shown in Table 1.

### (Wire Diameter)

As shown in Table 2, the wire diameter of each of the copper alloy wires prepared as samples is ϕ0.16 mm, ϕ0.18 mm, or ϕ0.35 mm.

### (Shape)

The casting material, extruded material, scalped wire rod, drawn wire material, and heat-treated material manufactured in each type of process are all round wires having a circular cross-section.

### (Properties)

The tensile strength (MPa), elongation at break (%), work hardening coefficient, and conductivity (% IACS) of each of the copper alloy wires prepared as samples were measured. Methods for measuring them are as described above.

### (Structure)

The cross-section of each of the copper alloy wires prepared as samples was taken and observed by SEM.

The copper alloy constituting each of the copper alloy wires prepared as samples had a structure containing copper-based crystals and a compound described below. The compound was a compound mainly containing iron and phosphorus. The composition of the compound can be measured by, for example, energy dispersive X-ray analysis (EDX).

### <Crystal Grain Size Difference>

The crystal grain size difference (μm) in the cross-section of each of the copper alloy wires prepared as samples was measured. A method for measuring the crystal grain size difference is as described above.

TABLE 1

| | | | | | | Manufacturing conditions | | | |
|---|---|---|---|---|---|---|---|---|---|
| | | | | | | | Reduction | | |
| | Composition | | | | | | of area by | Heat treatment | |
| | | | | | Mass | | conform | conditions | |
| Sample | mass % | | | | ratio | Type of | extrusion | Temperature | Time |
| No. | Cu | Fe | P | Sn | Fe/P | process | (%) | (° C.) | (h) |
| 1-1 | Bal. | 0.72 | 0.14 | 0.30 | 5.1 | A | 59 | 400 | 8 |
| 1-2 | Bal. | 0.72 | 0.14 | 0.30 | 5.1 | A | 59 | 440 | 8 |
| 1-3 | Bal. | 0.99 | 0.24 | 0.49 | 4.1 | A | 59 | 400 | 8 |
| 1-4 | Bal. | 0.99 | 0.24 | 0.49 | 4.1 | A | 59 | 440 | 8 |
| 1-5 | Bal. | 0.09 | 0.03 | 0.27 | 3.0 | A | 59 | 350 | 8 |
| 1-6 | Bal. | 0.09 | 0.03 | 0.27 | 3.0 | A | 59 | 420 | 8 |
| 1-101 | Bal. | 0.72 | 0.14 | 0.30 | 5.1 | A | 59 | 300 | 8 |
| 1-102 | Bal. | 0.72 | 0.14 | 0.30 | 5.1 | B | — | 400 | 8 |
| 1-103 | Bal. | 0.72 | 0.14 | 0.30 | 5.1 | B | — | 440 | 8 |
| 1-104 | Bal. | 0.99 | 0.24 | 0.49 | 4.1 | B | — | 420 | 8 |
| 1-105 | Bal. | 0.99 | 0.24 | 0.49 | 4.1 | B | — | 450 | 8 |
| 1-106 | Bal. | 0.09 | 0.03 | 0.27 | 3.0 | B | — | 350 | 8 |
| 1-107 | Bal. | 0.09 | 0.03 | 0.27 | 3.0 | B | — | 400 | 8 |
| 1-108 | Bal. | 0.68 | 0.15 | 0.34 | 4.5 | A | 42 | 420 | 8 |
| 1-109 | Bal. | 0.68 | 0.15 | 0.34 | 4.5 | A | 42 | 450 | 8 |

TABLE 2

| | Copper alloy wire | | | | | | | | | |
|---|---|---|---|---|---|---|---|---|---|---|
| | | | | | | | | | | Structure |
| | | | | | Size | Properties | | | | Crystal |
| | | | | | Wire | Tensile | | | Work | grain size |
| Sample | Composition (mass %) | | | | diameter | strength | Elongation | Conductivity | hardening | difference |
| No. | Cu | Fe | P | Sn | (mm) | (MPa) | at break (%) | (IACS %) | coefficient | (μm) |
| 1-1 | Bal. | 0.72 | 0.14 | 0.30 | 0.18 | 580 | 9 | 61 | 0.10 | 0.7 |
| 1-2 | Bal. | 0.72 | 0.14 | 0.30 | 0.18 | 500 | 10 | 64 | 0.16 | 0.4 |
| 1-3 | Bal | 0.99 | 0.24 | 0.49 | 0.16 | 570 | 11 | 64 | 0.11 | 0.9 |
| 1-4 | Bal. | 0.99 | 0.24 | 0.49 | 0.16 | 460 | 16 | 66 | 0.18 | 0.7 |
| 1-5 | Bal. | 0.09 | 0.03 | 0.27 | 0.16 | 510 | 11 | 68 | 0.11 | 0.9 |
| 1-6 | Bal. | 0.09 | 0.03 | 0.27 | 0.16 | 410 | 17 | 77 | 0.20 | 0.8 |
| 1-101 | Bal | 0.72 | 0.14 | 0.30 | 0.18 | 700 | 5 | 49 | 0.06 | 1.4 |
| 1-102 | Bal. | 0.72 | 0.14 | 0.30 | 0.18 | 570 | 8 | 61 | 0.04 | 2.0 |
| 1-103 | Bal. | 0.72 | 0.14 | 0.30 | 0.18 | 490 | 11 | 65 | 0.08 | 1.5 |
| 1-104 | Bal. | 0.99 | 0.24 | 0.49 | 0.16 | 560 | 10 | 64 | 0.10 | 2.0 |
| 1-105 | Bal. | 0.99 | 0.24 | 0.49 | 0.16 | 450 | 16 | 66 | 0.16 | 1.8 |
| 1-106 | Bal. | 0.09 | 0.03 | 0.27 | 0.16 | 480 | 7 | 68 | 0.01 | 3.3 |
| 1-107 | Bal. | 0.09 | 0.03 | 0.27 | 0.16 | 390 | 15 | 70 | 0.25 | 2.9 |
| 1-108 | Bal. | 0.68 | 0.15 | 0.34 | 0.35 | 490 | 8 | 71 | 0.11 | 1.5 |
| 1-109 | Bal. | 0.68 | 0.15 | 0.34 | 0.35 | 420 | 12 | 72 | 0.18 | 1.3 |

This test indicates the following. Hereinbelow, the copper alloy wires of Samples No. 1-1 to 1-6 are called first-group copper alloy wires. The copper alloy wires of Samples No. 1-101 to 1-109 are called second-group copper alloy wires.

### (Comparison of Structure)

The first-group copper alloy wires have small variations in crystal size. For example, as shown in FIG. 7, the copper alloy wire of Sample No. 1-1 has a structure containing crystals 11 uniform in size. In this structure, small compounds 15 are evenly dispersed. On the other hand, The second-group copper alloy wires have large variations in crystal size. For example, as shown in FIG. 8, the copper alloy wire of Sample No. 1-102 has a structure in which coarse crystals 110 are locally present. Further, this structure contains coarse compounds 150 unevenly distributed.

### (Comparison of Properties)

(1) The copper alloy wires having a crystal grain size difference of 1.0 μm or less have a better balance of strength and elongation as compared to the copper alloy wires having a crystal grain size difference of more than 1.0 μm. When Samples Nos. 1-1 and 1-2 and Samples Nos. 1-101—to 1-103, which are the same in the composition of the copper alloy, are compared, the first-group copper alloy wires have a tensile strength of 500 MPa or more and an elongation at break of 9% or more. Particularly, when Sample No. 1-1 and Sample No. 1-102 are compared, the copper alloy wire of Sample No. 1-1 has higher tensile strength and higher elongation at break than the copper alloy wire of Sample No. 1-102. Also when Samples Nos. 1-3 to 1-6 are respectively compared with Samples Nos. 1-104 to 1-107, almost the same results are obtained.
(2) The copper alloy wires having a crystal grain size difference of 1.0 μm or less further have a conductivity of 60% IACS or more. For this reason, the first-group copper alloy wires are excellent also in conductivity.
(3) The copper alloy wires having a crystal grain size difference of 1.0 μm or less have a work hardening coefficient of 0.1 or more. For this reason, the first-group copper alloy wires are also work-hardened easily to some extent.

### (Manufacturing Method)

(4) The copper alloy wires having a crystal grain size difference of 1.0 μm or less are manufactured by subjecting a continuous casting material to conform extrusion to achieve a reduction of area of 50% or more, then subjecting a manufactured extruded material to wire drawing, and further subjecting a manufactured drawn wire material to heat treatment at a specific temperature (confer the first-group copper alloy wires and the second-group copper alloy wires). A comparison between Samples Nos. 1-1 and 1-2 and Sample No. 1-101, which are the same in the composition of the copper alloy, indicates that even when conform extrusion is performed to achieve a reduction of area of 50% or more, elongation at break and conductivity are reduced due to a lower heat treatment temperature. A comparison between Samples Nos. 1-1 and 1-2 and Samples Nos. 1-108 and 1-109 indicates that even when conform extrusion is performed, the crystal grain size difference is more than 1.0 μm as long as the reduction of area by conform extrusion is less than 50%. On the other hand, when the continuous casting material is subjected only to cold working such as cold rolling or cold drawing without being subjected to conform extrusion, the structure after heat treatment has large variations in crystal size (see Samples Nos. 1-102 to 1-107).

It should be noted that in the above-described manufacturing method, the casting speed (m/min) can be increased (confer the casting speed in the type-A process and the casting speed in the type-B process). Therefore, a casting material is manufactured in mass quantities. An extruded material is also manufactured in mass quantities by using conform extrusion. Since wire drawing is performed on the extruded material, wire breakage is less likely to occur during wire drawing. Therefore, a drawn wire material is also manufactured in mass quantities. Further, as compared to the above-described case where cold rolling is performed, a temperature range usable for heat treatment in the above-described manufacturing method is wider. For these reasons, the above-described manufacturing method is capable of manufacturing a copper alloy wire having a crystal grain size difference of 1.0 μm or less with high productivity.

The present invention is not limited to these examples and is defined by the claims, and all changes which come within the meaning and range of equivalency of the claims are therefore intended to be embraced therein.

For example, in Test Example 1, the compositions of copper alloys, the conditions of conform extrusion, the wire drawing conditions and the heat treatment conditions, and the wire diameters can be changed.

### REFERENCE SIGNS LIST

1 Copper alloy wire
2 Copper alloy stranded wire
3 Covered wire
4 Covered wire with terminal
10 Extruded material
11 Crystal; 12 Edge; 14 Crystal grain boundary; 15 Compound
21 Elemental wire
31 Conductor; 32 Insulating layer
45 Terminal
70 Conform extruder
71 Wheel; 72 Recessed groove; 73 Die; 74 Shoe
75 Abutment; 76 Die chamber; 77 Opening
100 Material; 101 Dust
110 Coarse crystal; 150 Coarse compound
451 Connecting part; 452 Wire barrel part
453 Insulation barrel part
D Wire diameter; L, L1, L2, L3, Length
P1, P2, P3, P4 Intersection point; α, β Field of view

1. A copper alloy wire being a wire rod formed of a copper alloy and having a tensile strength of 400 MPa or more,
an elongation at break of 5% or more,
a conductivity of 60% IACS or more, and
a wire diameter of 0.5 mm or less, wherein
the copper alloy has a composition containing 0.05% by mass or more and 1.6% by mass or less of iron, 0.01% by mass or more and 0.7% by mass or less of phosphorus, and 0.05% by mass or more and 0.7% by mass or less of tin with the balance being copper and unavoidable impurities,
the copper alloy has a structure containing crystals, and
a crystal grain size difference determined as a difference between a maximum crystal grain size and a minimum crystal grain size in a cross-section is 1.0 μm or less.

2. The copper alloy wire according to claim 1, wherein the composition of the copper alloy contains less than 0.001% by mass of carbon.

3. The copper alloy wire according to claim 1, wherein a content ratio by mass of iron to phosphorus is 1.0 or more and 30 or less.

4. The copper alloy wire according to claim 1,
wherein the copper alloy wire has a work hardening coefficient of 0.1 or more.

5. A covered wire comprising a conductor and an insulating layer covering a periphery of the conductor, wherein
the conductor comprises a copper alloy stranded wire, and
the copper alloy stranded wire comprises the copper alloy wire according to claim 1.

6. A covered wire with terminal, comprising the covered wire according to claim 5 and a terminal attached to at least one of ends of the covered wire.

7. A method for manufacturing a copper alloy wire, comprising:
a first step of manufacturing a casting material formed of a copper alloy by continuous casting;
a second step of subjecting the casting material to conform extrusion to manufacture a linear extruded material;
a third step of subjecting the extruded material to wire drawing to manufacture a drawn wire material; and
a fourth step of subjecting the drawn wire material to heat treatment to manufacture a heat-treated material, wherein
the copper alloy has a composition containing 0.05% by mass or more and 1.6% by mass or less of iron, 0.01% by mass or more and 0.7% by mass or less of phosphorus, and 0.05% by mass or more and 0.7% by mass or less of tin with the balance being copper and unavoidable impurities,
a reduction of area by the conform extrusion is 50% or more,
a temperature of the extruded material just after conform extrusion is 350° C. or more, and
a temperature of the heat treatment is 350° C. or more.
